(19) United States
(12) Patent Application Publication
(10) Pub. No.: US 2014/0010396 A1
(43) Pub. Date: Jan. 9, 2014

(54) CIC Hearing Aid

(71) Applicants: Erdal Karamuk, Mannedorf (CH); Jan Angst, Hirzel (CH); Hilmar Meier, Herrliberg (CH); Roland Hug, Hinwil (CH); Andi Vonlanthen, Oberrohrdorf (CH); Matthias Riepenhoff, Zurich (CH)

(72) Inventors: Erdal Karamuk, Mannedorf (CH); Jan Angst, Hirzel (CH); Hilmar Meier, Herrliberg (CH); Roland Hug, Hinwil (CH); Andi Vonlanthen, Oberrohrdorf (CH); Matthias Riepenhoff, Zurich (CH)

(73) Assignee: Phonak AG, Staefa (CH)

(21) Appl. No.: 14/008,442

(22) PCT Filed: Mar. 29, 2011
(86) PCT No.: PCT/EP2011/054863

§ 371 Date: Sep. 27, 2013

(51) Int. Cl. H04R 25/02

(52) U.S. Cl. CPC H04R 25/02
USPC 381/328

(57) ABSTRACT

The invention relates to a CIC hearing aid (30) for operation within an ear canal (10) of a user, comprising a lateral module (32), a medial module (34) and a flexible joint assembly (36) connecting the medial end (38) of the lateral module and the lateral end (40) of the medial module in such a manner that the lateral module and the medial module are movable relative to each other in order to follow the shape of the ear canal, wherein the flexible joint assembly is adapted to removably receive an axially extending guide element (68) for temporarily stiffening the flexible joint assembly with regard to bending and/or axial motions when the hearing aid is pushed into the ear canal, and wherein the guide element is adapted to be removed at least from a medial portion (66) of the flexible joint assembly after insertion of the hearing aid.

The present invention relates to a CIC (Completely-In-the-Canal) hearing aid comprising a lateral module, a medial module and a flexible joint assembly connecting the medial module in such a manner that the lateral module and the medial module are movable relative to each other in order to follow the shape of the ear canal (“medial” designates the direction towards the tympanic membrane, and “lateral” designates the direction away from the tympanic membrane).

Typically, the medial module contains the hearing aid loudspeaker, while the lateral module includes the battery, the microphone and the audio signal processing electronics including an amplifier (alternatively, a third module may be provided which is connected to the lateral module and which includes one or more of these hearing aid components).

Hearing aids of this type are known, for example, from US 2007/0036379 A1, wherein the medial module and the lateral module are connected by a soft silicon sleeve which forms a joint region between the two modules, which joint region is hollow and has relatively thin walls, with electrical wires passing through the joint region from the lateral module to the medial module. The flexible silicon sleeve acts as an acoustic and mechanical decoupling and as a holding element for the lateral module and the medial module. The joint region also includes a relatively stiff member which is integrated in the silicon sleeve in order to limit the maximum bending angle of the joint, thereby preventing tilting of the hearing aid during insertion into the ear canal.

In general, CIC hearing aids of the above-mentioned type can be inserted very deeply into the ear canal, so that the loudspeaker can located very close to the ear drum. Typically, such hearing aids are designed to be worn within the ear canal for a few months without the need to replace the battery (this is achieved by minimizing power consumption).

Typically, the lateral module is primarily located in the cartilaginous part of the ear canal, while the medial module is primarily located in the bony part of the ear canal. The bony part of the ear canal is relatively pain sensitive but relatively stable during actions like speaking or chewing, while the cartilaginous part of the ear canal encounters large radial and axial deformations during such actions. Since the flexible joint of CIC hearing aids of the above-mentioned type has a certain flexural and axial stiffness, deformations of the cartilaginous part of the ear canal are, to some extent, mechanically conducted to the bony part of the ear canal, where incomfortable sensations may be caused. On the other hand a certain minimum flexural and axial stiffness of the joint is required, in order to allow for a reliable insertion procedure of the hearing aid into the ear canal, during which the joint has to transfer a pushing force from the lateral module to the medial module.

WO 00/42815 A1 relates to a CIC hearing aid comprising a medial loudspeaker module and a lateral battery/microphone module, which are connected by a flexible joint. The hearing aid includes a tube which extends from the medial end of the loudspeaker module via the flexible joint to the battery/microphone module, with the lateral end of the tube extending laterally beyond the battery/microphone module. The tube serves both as a vent channel and as a retrieval chord for removing the hearing aid from the ear canal.

U.S. Pat. No. 5,825,896 relates to a CIC hearing aid having a medial module and a lateral module connected by flexible joint which forms a hinge. The two modules share and are connected by a flexible circuit carrying all electrical components of the hearing aid.

U.S. Pat. No. 6,212,283 B1 relates to a CIC hearing aid comprising a medial module and a lateral module, which are connected by a ball joint, which is designed to limit its range of motion to prevent damage to the wiring conducted within the ball joint.

U.S. Pat. No. 4,539,440 relates to a CIC hearing aid comprising a corrugated housing, which is adjustable by an axial screw in a manner so as to adjust the radial dimension of the housing.

WO 96/31087 A1 relates to a cochlear electrode implant assembly, which comprises a guide wire for implantation of the cochlear electrode.

It is an object of the invention to provide for an articulated CIC hearing aid which has a high wearing comfort and which can be inserted into the ear canal in a reliable and safe manner.

According to the invention, this object is achieved by a hearing as defined in claim 1.

The invention is beneficial in that, by providing the flexible joint assembly with a removable, axially extending guide element, the flexural and axial stiffness of the joint assembly becomes adjustable by inserting and removing, respectively, the guide element, so that, when the guide element is inserted in the joint assembly, the stiffness necessary for reliable and safe insertion of the hearing aid into the ear canal is imparted to the joint assembly, while upon removal of the guide element the stiffness of the joint assembly is significantly reduced so that transfer of radial and axial deformations of the cartilaginous part of the ear canal to the bony part of the ear canal via the joint assembly can be minimized.

Preferred embodiments of the invention are defined in the dependent claims.

Hereinafter, examples of the invention will be illustrated by reference to the attached drawings, wherein:

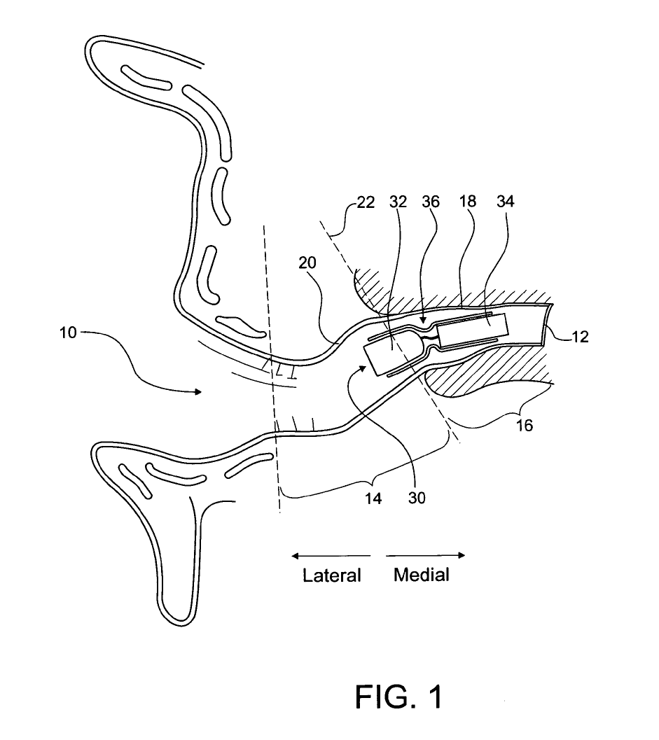

FIG. 1 is a lateral view of an example of a hearing aid according to the invention when positioned within the ear canal;

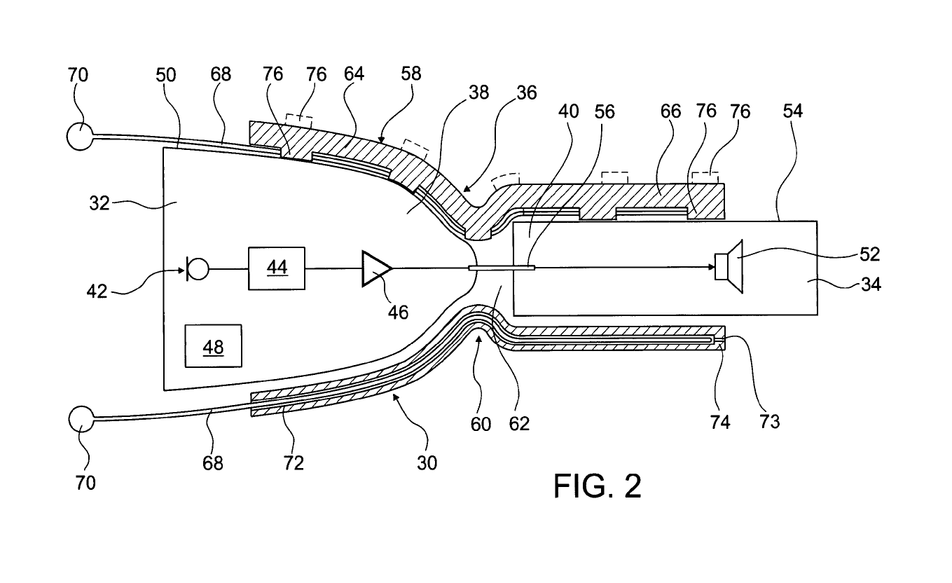

FIG. 2 is a lateral view illustrating an embodiment of a hearing aid according to the invention prior to being inserted into the ear canal;

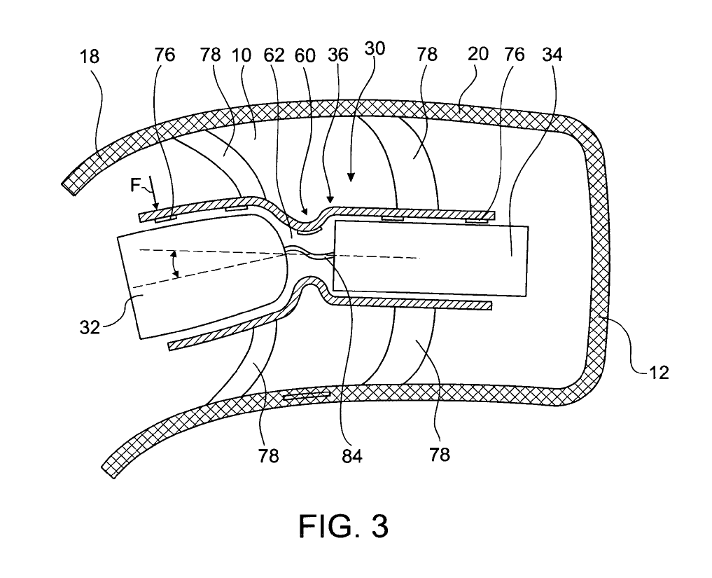

FIG. 3 is a lateral view of an embodiment of a hearing aid according to the invention after having been inserted into the ear canal;

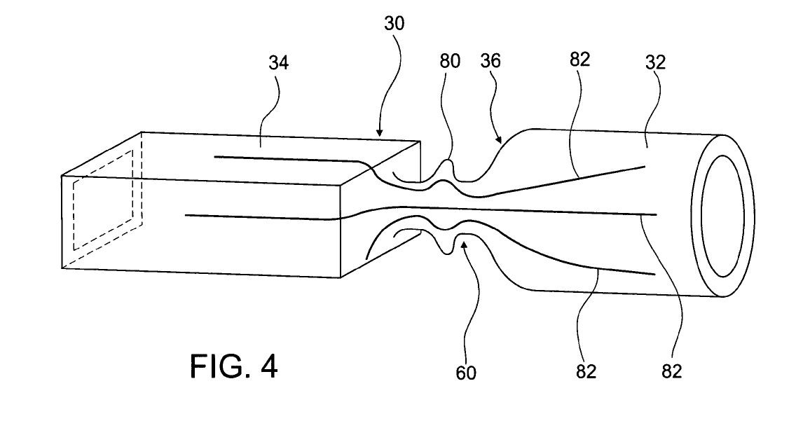

FIG. 4 is a perspective view of an embodiment of as hearing aid according to the invention prior to being inserted in to the ear canal;

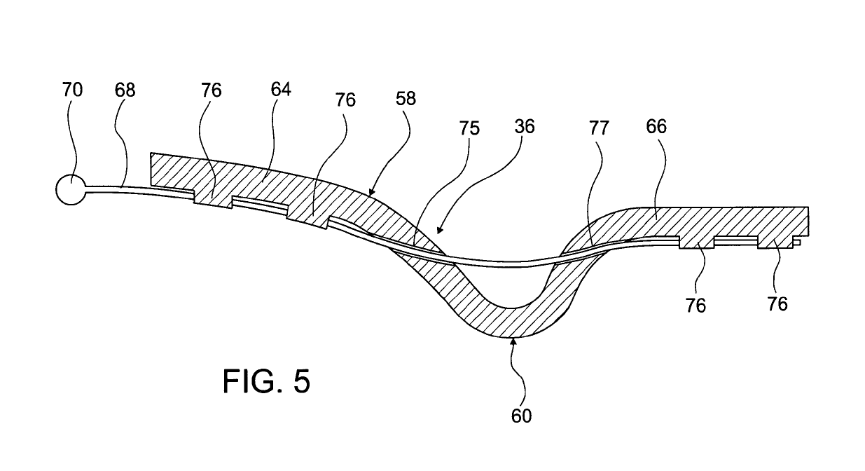

FIG. 5 is a view similar to that of FIG. 2, wherein an alternative embodiment is shown with the guide wire in the position in which the hearing aid is inserted into the ear canal, with only the upper part of the flexible joint assembly being shown;

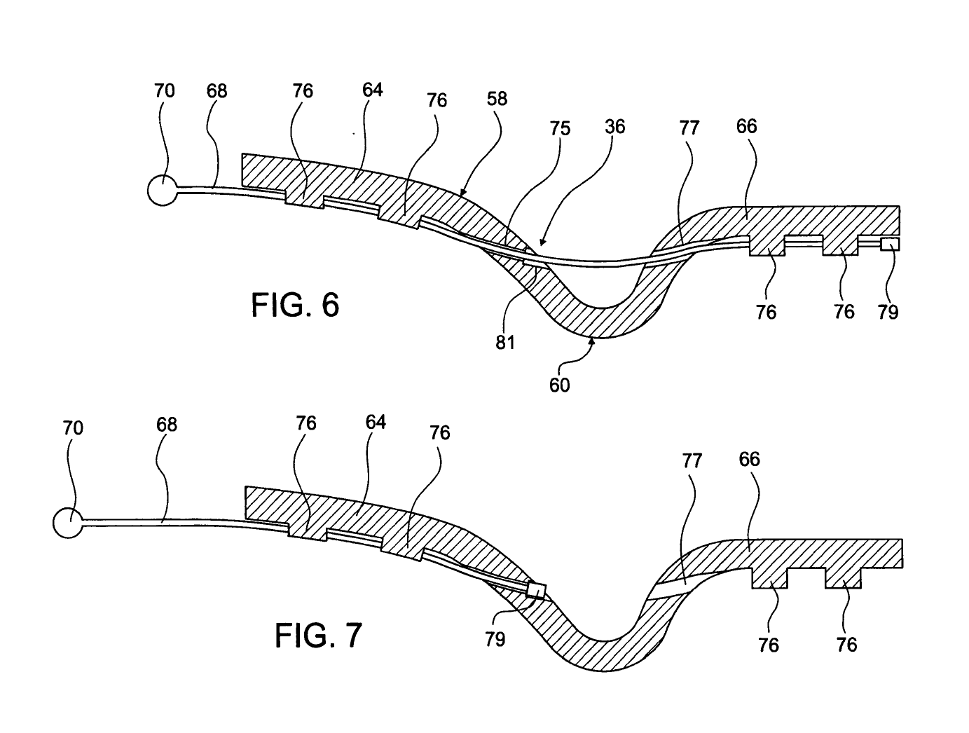

FIG. 6 is a view similar to that of FIG. 5, wherein a further alternative embodiment is shown with the guide wire in the position in which the hearing aid is inserted into the ear canal; and

FIG. 7 is a view of the embodiment of FIG. 6, wherein the guide wire has been partly withdrawn from the flexible joint assembly after the hearing aid has been inserted into the ear canal.

A shown in FIG. 1, the ear canal 10 comprises, in its lateral part (i.e. away from the tympanic membrane 12) a cartilaginous region 14, which is relatively soft due to the underlying cartilaginous tissue and, in its medial (towards the tympanic membrane 12) part a bony region 16, which is relatively rigid due to the underlying bony tissue. The skin 18 in the bony region 16 is relatively thin and more sensitive to touch or pressure than the skin 20 in the cartilaginous region 14. There is a characteristic bend in the ear canal 10, which roughly occurs at the bony-cartilaginous junction 22 separating the regions 14 and 16.

The hearing aid 30 shown in FIGS. 1 and 2 comprises a lateral module 32, a medial module 34 and a flexible joint assembly 36, which connects the medial end 38 of the lateral module 32 and the lateral end 40 of the medial module 34. The lateral module 32 comprises a microphone arrangement 42 for capturing audio signals from ambient sound, an audio signal processing unit 44 for processing the captured audio signals, a power amplifier 46, a battery 48 for supplying power to the electrical components of the lateral module 32 and a housing 50. The medial module 34 comprises a loudspeaker 52 and a housing 54. A wiring 56 extends from the lateral module 32 to the medial module 34 for supplying the processed amplified audio signals from the lateral module 32 to the speaker 52 of the medial module 32.

The flexible joint assembly 36 comprises an elastic sleeve 58 having a lateral portion 64 surrounding at least the medial end 38 of the lateral module 32, a medial portion 66 surrounding the lateral end 40 of the medial module 34, and a pivotal portion 60 enclosing a lumen 62 extending between the medial end 38 of the lateral module 34 and the lateral end 40 of the medial module 34. The lumen 62 includes the electrical wiring 56. The cross-section of the pivotal portion 60 is smaller than in the lateral portion 64 and the medial portion 66.

The lateral module 32 and the medial module 34 are spaced apart by the lumen 62 so as to enable pivoting movement of the medial module 34 relative to the lateral module 32, so that being inserted into the ear canal 10, the hearing aid 30 can follow the shape of the ear canal 10. In other words, during and after insertion of the hearing aid 30 into the ear canal 10, the modules 32 and 34 may take an angled position relative to each other.

This can be seen in FIG. 1, where the hearing aid 30 is shown in its final position in the ear canal 10, wherein the medial module 34 is located at a position in the bony part 16 of the ear canal close to the tympanic membrane 12, while the lateral module 32 is located in part in the cartilaginous region 14 and in part in the bony region 16. When the shape of ear canal 10 in the cartilaginous region 14 changes due to actions like speaking or chewing, the hearing aid 30 may follow such changes at least to some extent due to the flexibility of the pivotal portion 60 of the joint assembly 36. The flexibility of the pivotal portion 60 with regard to pivoting motion of the modules 32 and 34 relative to each other can be tailored by selecting the material of the sleeve 58, the wall thickness of the sleeve 58, the axial length of the portion 60 and the shape of the sleeve 58 in the pivotal portion 60. In particular, the flexibility may be enhanced by selecting a softer material, by reducing the wall thickness, by increasing the axial length and/or by introducing corrugations in the pivotal portion 60.

Preferably, the sleeve 58 is made of a silicon polymer.

Preferably, the pivotal portion 60 is designed such that the bending forces transmitted via the pivotal portion 60 from the lateral module 32 to the medial module 34 upon deformation of the ear canal 10 are so little that the wearer does not sense pain in the ear canal. Preferably, the transmitted bending forces are below the capillary venous return pressure of the vasculature of the canal epithelium.

More detailed examples of a hearing aid of the type described so far can be found in US 2007/0036379 A1.

According to the present invention, the joint assembly 36 is provided with a removable guide element 68, which extends in the axial direction for temporarily stiffening the joint assembly 36 with regard to bending and/or axial motions when the hearing aid 30 is pushed into the ear canal 10, and which can be removed from the joint assembly 36 once insertion of the hearing aid 30 into the ear canal 10 has been finished. Thereby the stiffness of the joint assembly 36, in particular the stiffness of the pivotal portion 60, can be enhanced during the insertion of the hearing aid.

In the example shown in FIG. 2 the guide element is designed as guide wire which is received by the joint assembly 36 in such a manner that it can be withdrawn by applying a pulling force at the lateral end 70 of the guide element 68, which extends beyond the lateral end of the lateral module 32.

According to the variant shown in the lower part of FIG. 2, the sleeve 58 is provided with a continuous channel 72 for receiving the guide wire 68. A stopper element 74 is provided at the medial end of the medial portion 66 of the sleeve 58, which acts as a stopper for the medial end of the guide wire 68 when a pushing force is applied to the guide wire 68. The channel 72 may act as a vent once the guide wire 68 has been removed. To this end, an opening should be provided at the medial end of the channel 72; for example, the stopper element 74 element may be provided with an opening 73.

The friction coefficient between guide wire and sleeve material should be low to ensure an easy gliding of the guide wire during its removal. The material of shell or guide wire can be modified to lower the friction coefficient. Preferably the guide wire 68 is provided with a low-friction surface coating, such as a surface coating made of Teflon. The use of silicone oil or an agent which lowers friction is possible.

According to the variant shown in the upper part of FIG. 2, the continuous channel 72 may be replaced by a plurality of axially spaced-apart channel sections 76, since it is not necessary that the sleeve 58 supports the guide wire 68 over its entire length. The channel sections 76 in the example of FIG. 2 are located at the inner side of the sleeve 58. Alternatively, such channel sections 76 may be located at the outer side of the sleeve 58, as indicated by dashed lines in FIG. 2.

Prior to insertion into the ear canal 10 the hearing aid 30 is pre-mounted with the guide wire 68. During the insertion procedure, the guide wire 68 serves to stiffen the pivoting portion 60 of the joint assembly 36, in particular in order to prevent the joint assembly 36 from jack-knifing, so that sufficient pushing force is transmitted to the medial module 34. During the insertion procedure the guide wire 68 also may serve to directly transmit pushing forces from its lateral end 70 to the stopper element 74. Once the positioning of the hearing aid 30 in the ear canal 10 is terminated, the guide wire 68 may be withdrawn from the hearing aid 30, thereby restoring the high flexibility of the pivotal portion 60.

The hearing aid 30 may comprise not only a single one but a plurality of guide elements 68 spaced-apart in the peripheral direction of the sleeve 58.

In FIG. 3 an example of a hearing aid 30 is shown, wherein the sleeve 58 is provided with a plurality of sealing retainers 78, which extend essentially radially from the sleeve 58 towards the skin 18, 20 of the ear canal 10, in order to hold the hearing aid 30 in position and to provide for an acoustic seal for minimizing feedback problems.

FIG. 4 shows an example, wherein the pivotal portion 60 is provided with a corrugation 80.

According to a preferred embodiment of the invention, the joint assembly 36 comprises strain relief means for preventing the strain in the joint assembly 36, and in particular in the pivoting portion 60, to exceed a certain maximum value when, after removal of the guide wire 68, a pulling force is applied to the lateral module 32 during removal of the hearing aid 30 from the ear canal 10. According to one embodiment, the strain relief means comprises axially extending fibers 82, which are integrated within the sleeve 58, in particular in the pivoting portion 60, as indicated in FIG. 4, and which are spaced apart in the peripheral direction.

According to an alternative embodiment, as shown in FIG. 3, the strain relief means may be formed by at least one band or chord 84, which is fixedly connected at one end to the lateral module 32 and at the other end to the medial module 34 and which is adapted to transfer axial pulling forces from the lateral module 32 to the medial module 34. Typically, such strain relief elements 84 will be designed such that they act to transfer axial pulling forces only when the strain in the joint assembly 36 exceeds a certain threshold, i.e. once the pivotal portion 60 already has been stretched in the axial direction to some extent.

The strain relief elements 82, 84 should be adapted to transfer large pulling forces while being highly flexible with regard to bending (for example, in the embodiment of FIG. 3 the strain relief element(s) 84 preferably should be more flexible with regard to bending than the joint assembly 36). Such characteristics may be obtained, for example, by using some kind of metal cable, which can be easily bent but is able to withstand large axial forces.

An alternative embodiment of the flexible joint assembly 36 is shown in FIG. 5 (where only the upper part of the flexible joint assembly, i.e. of the sleeve 58, is shown), wherein the guide element 68 extends partly outside the sleeve 58. While the guide element 68 extends inside the sleeve 58 in the lateral portion 64 and in the medial portion 66 (for example, through a plurality of axially spaced-apart channel sections 76 located at the inner side of the sleeve 58, as indicated in FIG. 5), it extends outside the sleeve 58 in the intermediate region, i.e. the pivotal portion 60, of the sleeve 58. To this end, both the lateral portion 64 and the medial portion 66 are provided with a feedthrough channel 75, 77 for receiving the guide element 68. Such arrangement in beneficial in that guide element 68 follows the shape of the sleeve 58 less closely than in the embodiments of FIG. 4 and hence may be less strongly bent than in the embodiments of FIG. 4. Thus the guide element 68 may be more stiff than in the embodiments of FIG. 4. As in the case of the other embodiments, the guide element 68 will be withdrawn once the hearing aid 30 has been brought into its final position in the ear canal 10.

A further alternative embodiment of the flexible joint assembly 36 is shown in FIGS. 6 and 7, wherein, like in the embodiment of FIG. 5, the guide element 68 extends outside the sleeve 58 in the pivotal portion 60 of the sleeve 58 and inside the sleeve in the lateral portion 64 and in the medial portion 66 of the sleeve. However, in contrast to the embodiments discussed so far, the sleeve 58 of the embodiment of FIGS. 6 and 7 is designed such that the guide element 68, after insertion of the hearing aid 30, is withdrawn only in part from the sleeve, namely only from the medial portion 66 (and the pivotal portion 60) of the sleeve 58, while part of the guide element 68 remains in the lateral portion 64 (in FIG. 6 the guide element 68 is shown in the position during insertion of the hearing aid 30 in the ear canal 10).

To this end, the medial end of the guide element 68 is provided with a retainer element 79 having an enlarged cross section, and the medial end of the feedthrough channel 75 of the lateral portion 64 of the sleeve 58 is designed as a receptacle 81 having an enlarged cross section compared to the remainder of the feedthrough channel 75. The feedthrough channel 77 and the channel sections 76 of the medial portion 66 of the sleeve 58 likewise have an enlarged cross section—compared to the feedthrough channel 75 and the channel sections 76 of the lateral portion 64 of the sleeve 58 for receiving—in order to the allow the retainer element 79 to pass through when the guide element 68 is partly withdrawn after insertion of the hearing aid 30 in the ear canal 10. Upon withdrawal of the guide element 68, the retainer element 79 engages within the receptacle 81 in order to prevent further withdrawal of the guide element 68 from the sleeve 58, as shown in FIG. 7.

Thereby the guide element 68 is prevented from being lost and may be used for removing the hearing aidd 30 from the ear canal 10 by pulling at the lateral end 70 of the guide element 68. With this embodiment, the feedthrough channel 77 and the channel sections 76 of the medial portion 66 of the sleeve 58 may serve as a vent, whereas the feedthrough channel 75 and the channel sections 76 of the lateral portion 64 of the sleeve 58 remain occupied by the guide element 68 also after placement of the hearing aid 30 in the ear canal 10. However, alternatively other vents may be provided in the lateral portion 64 or in the sealing retainers 78.

According to another variant, the guide element 68 may have a constant cross section along the entire tenth rather than having a larger cross section at the medial end (as shown in FIGS. 6 and 7 at 79). When the guide element has a constant cross section, it may be completely pulled out after insertion of the hearing aid 30 into the ear canal 10, in which case also the feedthrough channel 77 and the channel sections 76 of the lateral portion 64 of the sleeve 58 may serve as a vent. By using different types of guide elements 68, i.e. with different axial cross section profiles, the number of open vents may be chosen.

According to a further variant, when using a guide element 68 having an enlarged cross section at the medial end, the external part of the guide element 68, i.e. that part extending out of the ear canal 10, may be cut immediately after insertion of the hearing aid 30 into the ear canal 10, or it may be cut some time later. For example, as long as the outwardly extending part of the guid element 68 is not cut, the user has an easy and simple option to pull out the hearing aid 30 in case of uncomfortness. Such option may be desired in particular in the first period of use when the user user might not yet be accomodated to the device, so that he might desire to temporarily remove the device. Later, after being better accomodated to the device, the user may decide to cut the external part of the guide element 68, so that it is no longer visible.

1. A CIC hearing aid (30) for operation within an ear canal (10) of a user, comprising a lateral module (32), a medial module (34) and a flexible joint assembly (36) connecting the medial end (38) of the lateral module and the lateral end (40) of the medial module in such a manner that the lateral module and the medial module are movable relative to each other in order to follow the shape of the ear canal, wherein the flexible joint assembly is adapted to removably receive an axially extending guide element (68) for temporarily stiffening the flexible joint assembly with regard to bending and/or axial motions when the hearing aid is pushed into the ear canal, and wherein the guide element is adapted to be removed at least from a medial portion (66) of the flexible joint assembly after insertion of the hearing aid.

2. The hearing aid of claim 1, wherein the flexible joint assembly (36) and the guide element (68) are designed such the guide element is withdrawable from the flexible joint assembly by applying a pulling force at the lateral end (70) of the guide element.

3. The hearing aid of claim 1, wherein the guide element (68) is a guide wire.

4-5. (canceled)

6. The hearing aid of claim 1, wherein the flexible joint assembly (36) comprises a continuous channel (72) for receiving at least part of the guide element (68).

7. The hearing aid of claim 6, wherein the continuous channel (72) is designed to act as a vent once the guide element (68) has been removed.

8. The hearing aid of claim 1, wherein the flexible joint assembly (36) comprises a plurality of axially spaced apart channel sections (76) for receiving at least part of the guide element (68).

9. The hearing aid of claim 1, wherein the flexible joint assembly (36) comprises a stopper element (74) for acting as a stopper for the medial end of the guide element (68) when a pushing force is applied to the guide element.

10. The hearing aid of claim 1, wherein the flexible joint assembly (36) is designed such that the guide element (68) extends within the flexible joint assembly.

11. The hearing aid of claim 1, wherein the flexible joint assembly (36) is designed such that the guide element (68) extends at the periphery of the flexible joint assembly.

12. The hearing aid of claim 1, wherein the guide element (68) is designed to extend with its lateral end (70) laterally beyond the lateral end of the flexible joint assembly (32) for facilitating removal of the guide element.

13. The hearing aid of claim 1, wherein the flexible joint assembly (36) comprises an elastic sleeve (58) around the medial end (38) of the lateral module (32) and the lateral end (40) of the medial module (34), the sleeve having a pivotal portion (60) enclosing a lumen (62) between the medial end of the lateral module and the lateral end of the medial module.

14. (canceled)

15. The hearing aid of claim 13, wherein the lumen (62) includes electrical wiring (56) extending between the lateral module (38) and the medial module (34).

16. (canceled)

17. The hearing aid of claim 13, wherein the pivotal portion (60) includes at least one corrugation (80).

18. The hearing aid of claim 13, wherein a portion of the guide element (68) extends at the outer side of the sleeve (58), whereas the other portions of the guide element extends at the inner side of the sleeve.

19. (canceled)

20. The hearing aid of claim 1, wherein the guide element (68) is adapted to be completely removed from the flexible joint assembly (36) after insertion of the hearing aid (30).

21. The hearing aid of claim 1, wherein the medial end of the guide element (68) comprises a retainer element (79) for engaging with a mating stopper element (81) of the flexible joint assembly (36) in such a manner that the guide element is withdrawn from a medial portion (66) of the flexible joint assembly but remains in a lateral portion (64) of the flexible joint assembly.

22. The hearing aid of claim 1, comprising at least one strain relief element (82, 84) for preventing the strain in the flexible joint assembly (36) to exceed a given maximum when, after removal of the guide element (68), a pulling force is applied to the lateral module during removal of the hearing aid (30) from the ear canal (10).

23-26. (canceled)

27. The hearing aid of claim 1, wherein the medial module (34) comprises a loudspeaker (52) for converting processed audio signals into sound.

28. (canceled)

29. The hearing aid of claim 1, wherein the medial assembly (34) is for being inserted into the bony part (16) of the ear canal (10).

30. A method, comprising the steps of:
providing the flexible joint assembly (36) of the CIC hearing aid (30) defined by claim 1 with the guide element (68);
pushing the hearing aid (30) into the user's ear canal; and
removing the guide element at least from a medial portion (66) of the flexible joint assembly.
